(19) United States
(12) Patent Application Publication
(10) Pub. No.: US 2022/0291681 A1
(43) Pub. Date: Sep. 15, 2022

(54) SYSTEMS AND METHODS FOR EDGE AND GUARD DETECTION IN AUTONOMOUS VEHICLE OPERATION

(71) Applicant: 6 River Systems, LLC, Waltham, MA (US)

(72) Inventors: Arpit Gupta, Somerville, MA (US); James Barabas, Concord, MA (US)

(21) Appl. No.: 17/199,871

(22) Filed: Mar. 12, 2021

(51) Int. Cl. G05D 1/00; G01C 21/00; G05D 1/02

(52) U.S. Cl. CPC G05D 1/0088; G01C 21/3859; G05D 1/0246; G05D 1/0291; G05D 1/0223; G05D 2201/0216; G05D 2201/0211; G05D 2201/0206

(57) ABSTRACT

Described herein are systems and methods for autonomous vehicle operation, including systems and methods for edge and/or guard detection in autonomous vehicle operation. The system can include a processor configured to receive sensor data collected by a sensor of a first autonomous vehicle; determine that the sensor data is indicative of an edge in a navigation path of the first autonomous vehicle and that the edge is not a known feature; and adjust a map to include the edge, in which the map includes the navigation path.

### TECHNICAL FIELD

The following disclosure is directed to systems and methods for autonomous vehicle operation and, more specifically, systems and methods for edge and guard detection in autonomous vehicle operation.

### BACKGROUND

Autonomous vehicles can be configured to navigate open spaces (e.g., in air, over land, under water, etc.). For example, autonomous vehicles can be configured to navigate within an area that includes obstacles or humans. Such an area may be a warehouse, a retail store, a hospital, an office, etc. To successfully navigate such areas, autonomous vehicles can rely on one or more sensors.

### SUMMARY

Described herein are example systems and methods for autonomous vehicle operation, including systems and methods for edge and guard detection in autonomous vehicle operation.

In one aspect, the disclosure features a system for autonomous vehicle operation. The system can include a processor configured to: receive sensor data collected by a sensor of a first autonomous vehicle; determine that the sensor data is indicative of an edge in a navigation path of the first autonomous vehicle and that the edge is not a known feature; and adjust a map to include the edge, the map comprising the navigation path.

Various embodiments of the system can include one or more of the following features.

The system can include a communication device coupled to the processor and configured to transmit, to a processing unit of a second autonomous vehicle, an instruction to deactivate at least one of an edge detection routine or a guard detection routine when a presence of a guard disposed between the first autonomous vehicle and the edge is determined by the processor. The processor can be further configured to: determine whether the guard is a known feature in the navigation path and, upon determining that the guard is not a known feature, adjust the map to include the guard. The communication device can be further configured to transmit, to a controller of the second autonomous vehicle, an instruction to prevent speed reduction in the second autonomous vehicle as the second autonomous vehicle approaches the guarded edge in the navigation path. The instruction can be based on the adjusted map that includes the edge.

The system can include a communication device coupled to the processor and configured to transmit, to a computing system, the adjusted map. The computing system can be a remote computing system or a computing system of a second autonomous vehicle. The processor can be further configured to compare a first cluster of points in the sensor data to a second cluster of points in the sensor data, wherein each point is representative of a distance from a camera of the first autonomous vehicle to a surface; and determine a presence of the edge in the navigation path when the first cluster of points is significantly different from the second cluster of points. The first cluster of points can be at least 50% different in distance from the second cluster of points. The processor can be further configured to determine, based on the sensor data, a presence of a guard between the edge and the first autonomous vehicle.

In another aspect, the disclosure features a computer-implemented method for edge detection. The method can include receiving, by a processor, sensor data collected by a sensor of a first autonomous vehicle; determining, by the processor, that the sensor data is indicative of an edge in a navigation path of the first autonomous vehicle and that the edge is not a known feature; and adjusting, by the processor, a map to include the edge, the map comprising the navigation path.

Various embodiments of the method can include one or more of the following features.

The method can include transmitting to a processing unit of a second autonomous vehicle, by a communication device coupled to the processor, an instruction to deactivate at least one of an edge detection routine or a guard detection routine when a presence of a guard disposed between the first autonomous vehicle and the edge is determined by the processor. The method can further include determining, by the processor, whether the guard is a known feature in the navigation path; and upon determining that the guard is not a known feature, adjusting by the processor the map to include the guard.

The method can include transmitting to a controller of the second autonomous vehicle, by the communication device, an instruction to prevent speed reduction in the second autonomous vehicle as the second autonomous vehicle approaches the guarded edge in the navigation path. The instruction can be based on the adjusted map that includes the edge. The method can include transmitting to a controller of the first autonomous vehicle, by a communication device coupled to the processor, an instruction to reduce a speed of the first autonomous vehicle in the navigation path. The method can include transmitting to a computing system, by a communication device coupled to the processor, the adjusted map, wherein the computing system is a remote computing system or a computing system of a second autonomous vehicle.

The method can include comparing, by the processor, a first cluster of points in the sensor data to a second cluster of points in the sensor data, wherein each point is representative of a distance from a camera of the first autonomous vehicle to a surface; and determining, by the processor, a presence of the edge in the navigation path when the first cluster of points is significantly different from the second cluster of points. The first cluster of points can be at least 50% different in distance from the second cluster of points. The method can include determining, by the processor and based on the sensor data, a presence of a guard between the edge and the first autonomous vehicle.

In another aspect, the disclosure features a non-transitory computer-readable medium having instructions stored thereon that, when executed by one or more computer processors, cause the computer processors to perform operations including: receiving sensor data collected by a sensor of a first autonomous vehicle; determining that the sensor data is indicative of an edge in a navigation path of the first autonomous vehicle and that the edge is not a known feature; and adjusting a map to include the edge, the map comprising the navigation path.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the systems and methods described herein. In the following description, various embodiments are described with reference to the following drawings.

FIG. 1A is a model of an embodiment of an autonomous vehicle configured to execute tasks within a warehouse-type environment.

FIG. 1B is a model of another embodiment of an autonomous vehicle configured to execute tasks within a warehouse-type environment.

FIG. 2 is a diagram of an embodiment of a system for edge and guard detection in autonomous vehicle operation.

FIG. 3 is a flowchart of an embodiment of a method for edge and guard detection in autonomous vehicle operation.

FIG. 4 is a diagram of an embodiment of an autonomous vehicle configured to detect edges in its navigation path.

FIGS. 5A-5B are diagrams of embodiments of an autonomous vehicle configured to detect guards in its navigation path.

FIG. 6 is a block diagram of an embodiment of a computer system used in implementing the systems and methods described herein.

### DETAILED DESCRIPTION

In a warehouse setting (or in a retail store, a grocery store, a hospital, etc.), autonomous vehicles can navigate within aisles or spaces of the warehouse according to predetermined or variable paths. Additionally, autonomous vehicles have to navigate in coordination with or around other autonomous vehicles and/or human workers. To do so safely and efficiently, the autonomous vehicles rely on one or more sensors configured to capture images and/or depth information.

While navigating an interior space, autonomous vehicles may detect unexpected edges (e.g., drop-offs, pits, brinks, holes, etc.) while navigating in an interior space (e.g., of a warehouse). When an edge is detected, the vehicle may typically stop or slow down to prevent harm to the vehicle or a human being (e.g., positioned on a lower level below the edge). However, this behavior may also result in inefficiency in vehicle operation, especially if the vehicle is able to travel safely near the edge. Additionally or alternatively, the vehicle may determine whether a guard (e.g., railing, fencing, barrier, etc.) exists to make the edge safe to approach or travel along. Disclosed herein are systems and methods for detecting edges and/or guards during autonomous vehicle operation.

The technology described herein may be employed in mobile carts of the type described in, for example, U.S. Pat. No. 9,834,380, issued Dec. 5, 2017 and titled “Warehouse Automation Systems and Methods,” the entirety of which is incorporated herein by reference and described in part below.

### Application to Autonomous Warehouse Carts

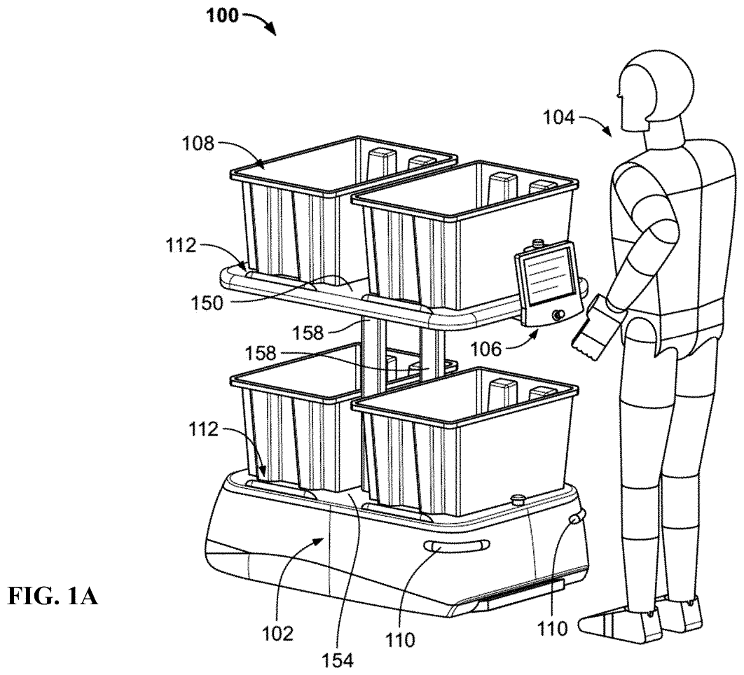

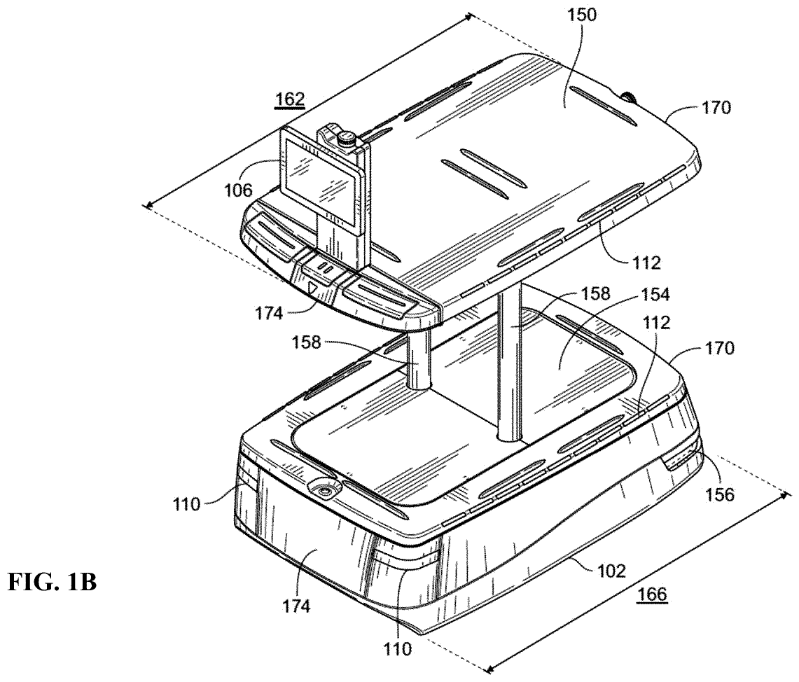

FIG. 1A depicts an enhanced cart system 100 including an enhanced cart 102 (e.g., an autonomous vehicle). As illustrated, one or more enhanced carts, often referred to in the industry as picking carts, can work alongside one or more warehouse workers 104 (also referred to as associates) to move inventory items around a warehouse. The enhanced carts 102 are intended to assist in most warehouse tasks, such as picking, re-stocking, moving, sorting, counting, or verifying items (e.g., products). These carts 102 can display information to the associate 104 through the use of a user interface (e.g., screen) 106 and/or onboard visual and/or audible indicators that improve the performance of the associates 104. The cart 102 can be propelled by a motor (e.g., an electric motor) that is coupled to a power source (e.g., a battery, a supercapacitor, etc.), such that the cart 102 moves autonomously and does not require being pushed or pulled by a human or other force. The cart 102 may travel to a charging area to charge its battery or batteries.

Referring still to FIG. 1A, the enhanced carts 102 may be configured to carry one or many similar or distinct storage containers 108, often in the form of totes or boxes, that can be used to hold one or more different products. These storage containers 108 may be removable from the enhanced cart 102. In some cases, each container 108 can be used as a separate picking location (i.e., one container 108 is a single order). In other cases, the containers 108 can be used for batch picking (i.e., each container 108 can contain multiple complete or partial orders). Each container 108 may be assigned to one or many different stations for post-pick sortation and processing. In one embodiment, one or more of the containers 108 are dedicated to batch picking of multiple types of products and another one or more containers 108 are dedicated to picking multiple quantities of a single product (e.g., for orders that only have one item). This singleton picking allows the warehouse to skip secondary sortation and deliver products directly to a packaging station. In another embodiment, one or more of the containers 108 are assigned to order picking (e.g., for potentially time sensitive orders) and one or more of the containers 108 are assigned to batch picking (e.g., for lower cost or less time sensitive orders). In yet another embodiment, one or more of the containers 108 carry product that will be used to re-stock product into storage locations. Another option is for the enhanced cart 102 to move product and/or shipments throughout the warehouse as needed between different stations, such as packing and shipping stations. In yet another implementation, one or more of the containers 108 is left empty to assist in counting product into and then back out of the container 108 as part of a cycle count task regularly carried out in warehouses for inventory management. The tasks may be completed in a mode dedicated to one task type or interleaved across different task types. For example, an associate 104 may be picking products into container “one” on the enhanced cart 102 and then be told to grab products from container “two” on the enhanced cart 102 and put them away in the same aisle.

FIG. 1B is an alternative embodiment of the enhanced cart 102, and is shown (for ease of understanding) without the storage containers 108 being present. As before, the enhanced cart 102 includes the screen 106 and lighting indicators 110, 112. In operation, the storage containers 108 may be present on the enhanced cart 102 depicted in FIG. 1B. With reference to both FIGS. 1A and 1B, the enhanced cart 102 may include first and second platforms 150, 154 for supporting a plurality of containers 108 capable of receiving products. At least one support 158 may support the first platform 150 above the second platform 154. The at least one support 158 may be substantially centrally-located along respective lengths 162, 166 of the first and second platforms 150, 154 between front and back ends 170, 174 thereof and may support the first and second platforms 150, 154 at locations disposed within interior portions of the first and second platforms 150, 154. As illustrated in FIG. 1B, the front end 170 of the cart 102 may define a cutout 156. There may be one or more sensors (e.g., light detecting and ranging (LiDAR) sensors) housed within the cutout 156. The cutout 156 permits the sensor(s) to view and detect objects in front of and to the side of (e.g., more than 180° around) the cart 102.

The following discussion focuses on the use of autonomous vehicles, such as the enhanced cart 102, in a warehouse environment, for example, in guiding workers around the floor of a warehouse and carrying inventory or customer orders for shipping. However, autonomous vehicles of any type can be used in many different settings and for various purposes, including but not limited to: guiding shoppers or stocking inventory in a retail store, driving passengers on roadways, delivering food and medicine in hospitals, carrying cargo in shipping ports, cleaning up waste, etc. The autonomous vehicles can be employed in a warehouse-like environment open to the public (e.g., big box stores or wholesalers). This disclosure, including but not limited to the technology, systems, and methods described herein, is equally applicable to any such type of autonomous vehicle.

### Computing Systems for Autonomous Vehicle Operation

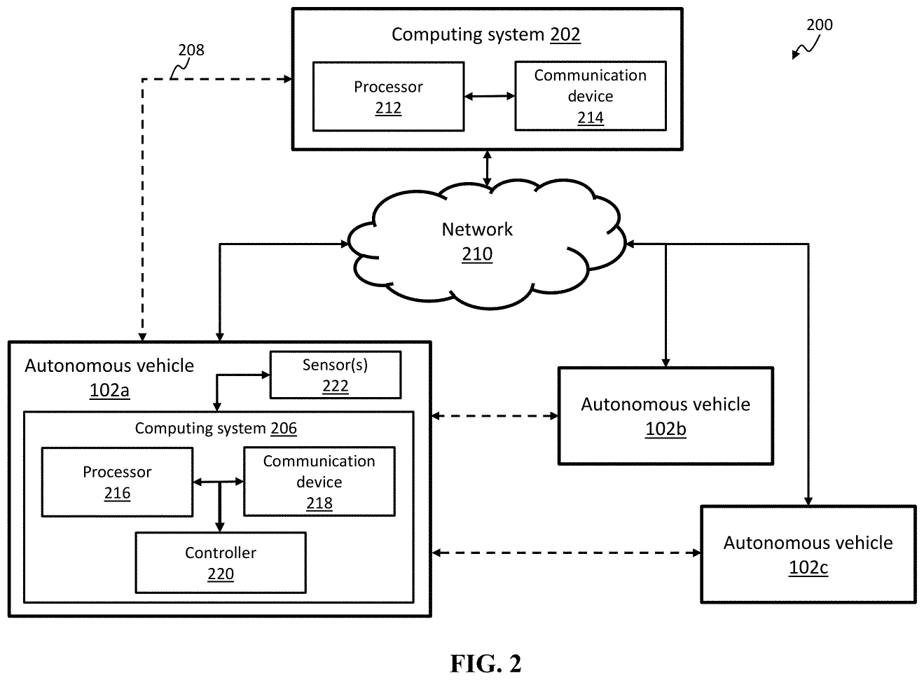

FIG. 2 illustrates a system 200 configured for sensor data adjustment in autonomous vehicles. The system 200 may include a remote computing system 202 configured to be coupled directly or indirectly to one or more autonomous vehicles 102a, 102b, 102c (collectively referred to as 102). For instance, the remote computing system 202 may communicate directly with the computing system 206 of an autonomous vehicle 102 (e.g., via communication channel 208). Additionally or alternatively, the remote computing system 202 can communicate with one or more autonomous vehicles 102 via a network device of network 210. In some embodiments, the remote computing system 202 may communicate with a first autonomous vehicle (e.g., vehicle 102a) via a second autonomous vehicle (e.g., vehicle 102b).

The example remote computing system 202 may include one or more processors 212 coupled to a communication device 214 configured to receive and transmit messages and/or instructions (e.g., to and from autonomous vehicle(s) 102). The example vehicle computing system 206 may include a processor 216 coupled to a communication device 218 and a controller 220. The vehicle communication device 218 may be coupled to the remote communication device 214. The vehicle processor 216 may be configured to process signals from the remote communication device 214 and/or vehicle communication device 218. The controller 220 may be configured to send control signals to a navigation system and/or other components of the vehicle 102, as described further herein. The vehicle 102 can include one or more sensors 222 configured to capture sensor data (e.g., images, video, audio, depth information, etc.) and transmit the sensor data to the remote computing system 202 and/or to the vehicle computing system 206. As discussed herein and unless otherwise specified, the term “computing system” may refer to the remote computing system 202 and/or the vehicle computing system 206.

The computing system(s) may receive and/or obtain information about one or more tasks, e.g., from another computing system or via a network. In some cases, a task may be customer order, including the list of items, the priority of the order relative to other orders, the target shipping date, whether the order can be shipped incomplete (without all of the ordered items) and/or in multiple shipments, etc. In some cases, a task may be inventory-related, e.g., restocking, organizing, counting, moving, etc. A processor (e.g., of system 202 and/or of system 206) may process the task to determine an optimal path for one or more autonomous vehicles 102 to carry out the task (e.g., collect items in a “picklist” for the order or moving items). For example, a task may be assigned to a single vehicle or to two or more vehicles 102.

The determined path may be transmitted to the controller 220 of the vehicle 102. The controller 220 may navigate the vehicle 102 in an optimized sequence of stops (also referred to as a trip) within the warehouse to collect or move items. At a given stop, a worker near the vehicle 102 may physically place the item into a container 108 for the vehicle 102 to carry. Alternatively or additionally, the autonomous vehicle 102 may include an apparatus (e.g., a robotic arm) configured to collect items into a container 108.

### Edges and Guards

Autonomous vehicles can be tasked with collecting items, moving items, and/or shelving items within the warehouse. While navigating to complete such tasks, an autonomous vehicle may encounter an unexpected and/or temporary edge in its navigation path that may cause the vehicle to stop or slow down unnecessarily, thereby reducing its efficiency in completing its tasks. Such an edge may exist at loading dock bays (e.g., near the perimeter of the warehouse), on mezzanines, on split levels, at bridges between buildings or portions of the warehouse, stairways, open gates, etc. The vehicle may stop or slow down to reduce a danger of falling off the edge and to prevent damage to the vehicle and/or harm to humans (e.g., if the vehicle fell off the edge on a human).

In some cases, a vehicle that is disoriented according to its programmed or internal map may “believe” that the vehicle is somewhere else in the warehouse and encounter an edge it does not expect. The edges may be particularly hazardous in this situation if the vehicle does not utilize the appropriate level of risk in approaching the edge. Despite this, the autonomous vehicles may be configured to prevent itself from driving off an edge, e.g., by avoiding areas with detected edges or by automatically stopping or significantly slowing near a detected edge.

In some instances, edges may be guarded by a railing or fence to prevent harm to the vehicle or to humans. An autonomous vehicle may travel along a guarded edge without significant precautions (e.g., stopping, slowing down, changing route, etc.) as compared to an unguarded edge.

In some instances, the edges and/or guards may be permanent, semi-permanent, periodic, sporadic, seasonal, or fixed for an extended amount of time (e.g., weeks, months, years, etc.). An edge or guard that is not present during the initial mapping of a warehouse may not be accounted for and therefore not available in the map for the vehicle 102. Over time, the warehouse may be modified with one or more new edges or guards. Additionally or alternatively, the warehouse may be modified with new areas, floors, hallways, partitions, rooms, bays, etc. which may necessitate new edges and/or guards. In another example, the warehouse may be modified with a seasonal or time-dependent edge or guard. This may be true, e.g., when loading bay doors or guards are open during certain times of the day (e.g., early morning or late evening for deliveries or shipping) or when different areas of a warehouse are opened up to handle the increase in holiday shopping.

These unknown edges may cause the vehicle to stop, slow down, or divert unnecessarily, thereby reducing its efficiency in completing its tasks. For instance, the sensors 222 of the vehicle 102 may detect an edge in the path of the vehicle 102 as the vehicle navigates and send a signal to the controller (e.g., directly or by way of the processor) to slow down and stop the vehicle. Additionally, the assessment of an edge and/or guard by the sensors and/or processor of the vehicle may require computational resources that may not be available or may be costly.

### Edge and Guard Detection

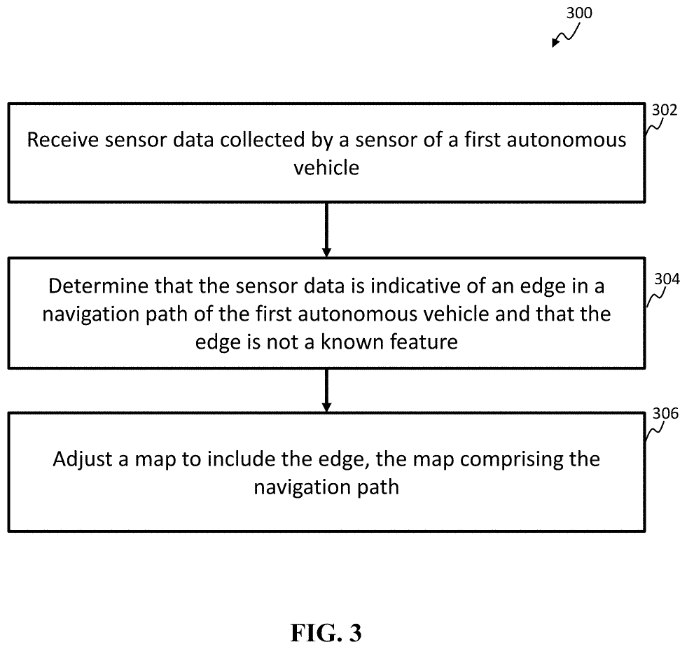

An automated system can be configured to appropriately respond to a detected edge in the navigation path of an autonomous vehicle. The automated system can be part of an autonomous vehicle and/or a remote computing system. FIG. 3 is an example method for edge detection in autonomous vehicle operation.

In step 302, a processor (e.g., a processor 212 or processor 216) may receive sensor data collected by a sensor of an autonomous vehicle 102. An autonomous vehicle can be configured to collect sensor data as it travels along a navigation path. Sensor data (image data, depth data, LiDAR sensor data, etc.) may be collected and/or generated by one or more sensors 222 (e.g., a camera, a depth sensor, a LiDAR sensor, etc.) coupled to the vehicle 102. In some embodiments, the processor 216 of the vehicle may transmit the sensor data to a processor 212 of a remote computing system 202.

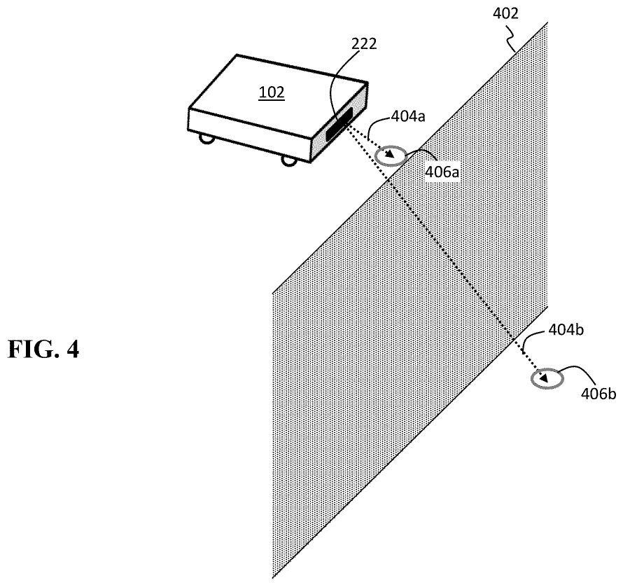

In step 304, the processor (e.g., a processor 212 or processor 216) can be configured to determine whether the sensor data is indicative of an edge in the navigation path of the vehicle 102. The controller 220 may send one or more control signals to approach the edge in small increments to obtain clearer sensor data. In some embodiments, a processor can compare a cluster of distance points collected by the sensors in two different locations. FIG. 4 illustrates a vehicle 102 approaching the edge 402 of a first level. The sensor 222 may detect a first distance 404a (e.g., 6 inches) to a first set of points 406a on the first level and a second distance 404b (e.g., 6 feet) to a second set of points 406b on the second level. A processor may compare the first distance to the second distance to determine the extent of the difference. If there is a significant difference (e.g., at least 30%, at least 40%, at least 50%, or more difference) between the two sets of points 406a and 406b, the processor may determine that an edge 402 exists between the sets of points 406a, 406b. In another example, the processor may input the sensor data into a trained machine learning model to determine whether an edge exists. For instance, the processor may divide the image or depth data may be divided into segments and apply a classifier to the segments to determine whether an edge is present.

In some embodiments, the processor can be configured to determine whether sensor data is indicative of a guard proximate to the edge. In some embodiments, the processor may determine a sufficient and/or high-enough probability (e.g., as compared to a threshold) of a guard and send an instruction to the controller 220 to approach the edge. For example, the processor may receive additional or different sensor data than the sensor data received for determining an edge in step 304. The processor may use any one or more of the techniques for determining edge, as described above, to determine the presence of a guard. In some implementations, the processor can be configured to instruct the controller 220 of the vehicle to approach the edge (e.g., slowly, in spurts, etc.) to determine the dimensions of the edge and/or whether a guard exists to prevent the vehicle from falling. The processor may send an instruction to the controller 220 to approach the edge or expected guard to obtain better sensor data and confirm the presence of a guard. In some embodiments, if a guard has been detected within the field-of-view of one or more of its sensors, the vehicle may change (e.g., rotate) its field-of-view or travel parallel to the detected edge to determine whether the edge is guarded at some, most, or all portions.

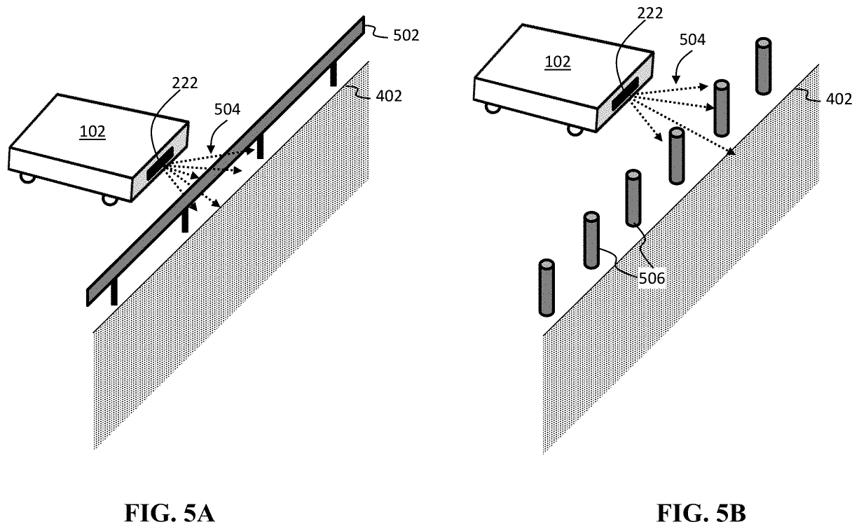

FIG. 5A illustrates a vehicle 102 approaching an edge 402 having a guard 502. In some embodiments, the sensors 222 may be configured to detect whether a guard 502 exists along the edge. For example, the sensors 222 may collect a series 504 of images or depth data (e.g., up-and-down, side-to-side, etc.) to determine whether a guard 502 is proximate the edge 402. Such a guard may make travel around or along the edge easier or more efficient for the vehicle. For example, the guard may appear as an obstacle between the vehicle and the edge (e.g., near the edge). In some cases, as illustrated in FIG. 5A, the guard 502 may appear continuous for an extended portion of the edge (e.g., for several feet or meters). In some cases, as illustrated in FIG. 5B, the guard 506 may appear as pillars 506 proximate the edge 402. For example, the pillars 506 may be distanced a particular width apart (e.g., corresponding to less than the width of an autonomous vehicle 102). Accordingly, images or depth data of these pillars 506 may be analyzed to discern the width and determine whether the pillars are a guard for the vehicle 102.

In some embodiments, a processor can be configured to determine the presence of a guard without first determining an edge. In some cases, if a guard is first detected, then the processor may not look for an edge. In some cases, if a guard is first detected, the processor may transmit an instruction to the controller 220 to travel the length of the guard. The processor may transmit an instruction to the sensors 222 to inspect the length of the guard to determine if there are any unprotected portions of the edge. The processor may accordingly map these portions as “unsafe”.

In some embodiments, the processor may determine the expected time duration of the guard at a particular edge. For example, if the guard is near a loading bay, the processor may associate the guard with an expected time period (e.g., early morning delivery time window). This expected time may be used later to determine whether other vehicles 102 should expect the guard to be in position if they navigate near the particular location.

In some embodiments, upon reaching an edge and/or guard, a vehicle 102 that is lost or disoriented may communicate (e.g., via communication device 218) to another computing system (e.g., system 202) to send help from another vehicle or human to guide it back to safety. While waiting for a “rescue”, the lost vehicle may be configured to explore the edge or guard to determine whether it can progress past the area. Note that, in some instances, a lost vehicle may not update the map and/or broadcast the map if it does not know to which portion of the map to associate the detected edge and/or detected guard.

In some embodiments, a communication device (e.g., 214 or 218) may transmit sensor data (pre-processing or post-processing) to a user interface to obtain input from a human (e.g., a warehouse worker or manager) to determine whether an edge and/or guard is present. If there is a detected edge, the user interface may seek approval or confirmation that there is a guard present near the detected edge.

In some embodiments, the processor can be configured to determine whether the edge is a known feature. For example, the processor can compare any collected and/or derived information about the edge (e.g., sensor data, determined dimensions, etc.) to the map of the autonomous vehicle 102. The map can be stored in a memory of the vehicle's computing system 206 or accessed from a remote computing system (e.g., system 202).

In step 306, the processor may be configured to adjust (e.g., update, correct, replace, overwrite, reconfigure, mark, tag, etc.) a map of the vehicle 102 to include the detected edges and/or guards. A communication device (e.g., device 214 or 218) coupled to the processor can be configured to send (e.g., broadcast) information including the existence, positioning, and/or dimensions of edges and/or guards to other autonomous vehicles (e.g., 102b, 102c) or to the remote computing system 202. In some embodiments, this information may be used in adjusting the map of one or more vehicles 102. One or more benefits can be profited by broadcasting edge and/or guard detection information to other vehicles. For example, processing resources by other vehicles or computing systems can be conserved. Speed reduction can be prevented, thereby preventing inefficiencies and/or maintaining warehouse productivity. In some cases, the edge detection capabilities and/or routines in other vehicles may be deactivated upon receiving an updated map. Deactivation may include turning off or bypassing edge detection. Deactivation may include discarding or adjusting sensor data. In some embodiments, one or more vehicles 102 may be designated as edge and/or guard detection vehicles. For example, such a designated vehicle may patrol the warehouse within certain time frames (e.g., during down times or predetermined slow times) or continuously to detect edges and/or guards and broadcast this information to other vehicles.

In some embodiments, the map may be a stored map (e.g., in a memory accessed by the processor) of the warehouse floor for autonomous vehicles 102. The newly-detected edges in the map may be associated with a marker or tag indicating whether it is safe (e.g., guarded or not) for a vehicle to travel nearby. In some embodiments, adjusting the map of one or more vehicles 102 can include marking particular areas (e.g., impassible areas, unsafe areas, etc.). Other autonomous vehicles that are navigating at locations in the warehouse where the stored map has indicated a guarded edge are able to reduce their inefficiencies by travelling without additional precautions. In some implementations, these other autonomous vehicles are also able to save computing power by turning off their edge detection modules in these areas. Alternatively, the speed limits near the areas of unguarded edges may be adjusted (e.g., lowered). In some embodiments, the area associated with the unguarded edge may be blocked as a “no-travel zone” for vehicles (e.g., until it becomes safe to do so). In this case, vehicles may be rerouted for some time to avoid this area while maintaining an expected level of efficiency.

In some embodiments, the processor may determine the expected duration of the guard at a particular edge. For example, if the guard is near a loading bay, the processor may associate the guard with an expected time period (e.g., early morning delivery time window). This expected time may be used later to determine whether other vehicles 102 should expect the guard to be in position if they navigate near the particular location.

In some embodiments, one or more autonomous vehicles 102 may perform a periodic or intermittent check to see if a previously-detected guard was a temporary or permanent guard. For example, once a first autonomous vehicle 102a detects the guard (e.g., as illustrated in FIGS. 5A-5B), a second vehicle 102b travelling through the same area may check to see if the guard persists. In some cases, the second vehicle 102b may check for a guard without checking for an edge to save on processing resources. This may be useful when a guard is removed from a particular area, e.g., a loading dock. For example, the time between guard checks by one or more autonomous vehicles 102 may depend on the expected change to the guard.

### Computer-based Implementations

In some examples, some or all of the processing described above can be carried out on a personal computing device, on one or more centralized computing devices, or via cloud-based processing by one or more servers. In some examples, some types of processing occur on one device and other types of processing occur on another device. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, such as flash-based memory, can be used.

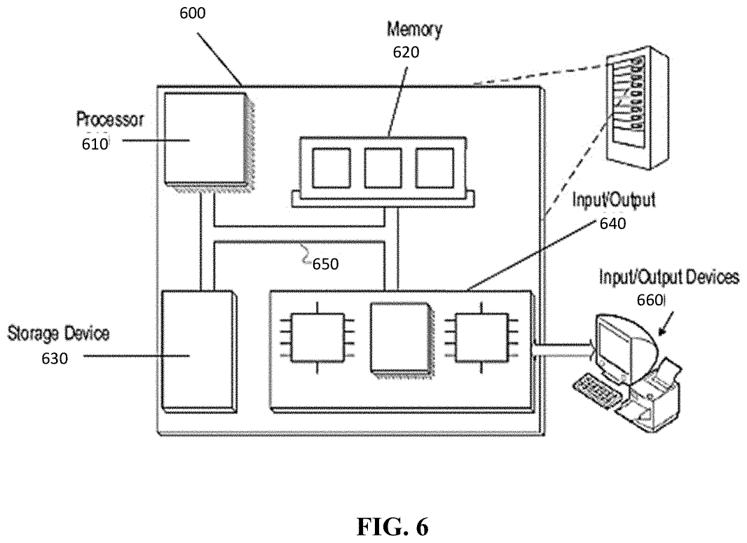

FIG. 6 is a block diagram of an example computer system 600 that may be used in implementing the systems and methods described herein. General-purpose computers, network appliances, mobile devices, or other electronic systems may also include at least portions of the system 600. The system 600 includes a processor 610, a memory 620, a storage device 630, and an input/output device 640. Each of the components 610, 620, 630, and 640 may be interconnected, for example, using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630.

The memory 620 stores information within the system 600. In some implementations, the memory 620 is a non-transitory computer-readable medium. In some implementations, the memory 620 is a volatile memory unit. In some implementations, the memory 620 is a non-volatile memory unit.

The storage device 630 is capable of providing mass storage for the system 600. In some implementations, the storage device 630 is a non-transitory computer-readable medium. In various different implementations, the storage device 630 may include, for example, a hard disk device, an optical disk device, a solid-date drive, a flash drive, or some other large capacity storage device. For example, the storage device may store long-term data (e.g., database data, file system data, etc.). The input/output device 640 provides input/output operations for the system 600. In some implementations, the input/output device 640 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 660. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 630 may be implemented in a distributed way over a network, such as a server farm or a set of widely distributed servers, or may be implemented in a single computing device.

Although an example processing system has been described in FIG. 6, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A system for autonomous vehicle operation, the system comprising:
a processor configured to:
receive sensor data collected by a sensor of a first autonomous vehicle;
determine that the sensor data is indicative of an edge in a navigation path of the first autonomous vehicle and that the edge is not a known feature; and
adjust a map to include the edge, the map comprising the navigation path.

2. The system of claim 1, further comprising:
a communication device coupled to the processor and configured to transmit, to a processing unit of a second autonomous vehicle, an instruction to deactivate at least one of an edge detection routine or a guard detection routine when a presence of a guard disposed between the first autonomous vehicle and the edge is determined by the processor.

3. The system of claim 2, wherein the communication device is further configured to:
transmit, to a controller of the second autonomous vehicle, an instruction to prevent speed reduction in the second autonomous vehicle as the second autonomous vehicle approaches the guarded edge in the navigation path.

4. The system of claim 2, wherein the processor is further configured to:
determine whether the guard is a known feature in the navigation path; and
upon determining that the guard is not a known feature, adjust the map to include the guard.

5. The system of claim 2, wherein the instruction is based on the adjusted map that includes the edge.

6. The system of claim 1, further comprising:
a communication device coupled to the processor and configured to transmit, to a computing system, the adjusted map, wherein the computing system is a remote computing system or a computing system of a second autonomous vehicle.

7. The system of claim 1, wherein the processor is further configured to:
compare a first cluster of points in the sensor data to a second cluster of points in the sensor data, wherein each point is representative of a distance from a camera of the first autonomous vehicle to a surface; and
determine a presence of the edge in the navigation path when the first cluster of points is significantly different from the second cluster of points.

8. The system of claim 7, wherein the first cluster of points is at least 50% different in distance from the second cluster of points.

9. The system of claim 7, wherein the processor is further configured to:
determine, based on the sensor data, a presence of a guard between the edge and the first autonomous vehicle.

10. A computer-implemented method for edge detection, the method comprising:
receiving, by a processor, sensor data collected by a sensor of a first autonomous vehicle;
determining, by the processor, that the sensor data is indicative of an edge in a navigation path of the first autonomous vehicle and that the edge is not a known feature; and
adjusting, by the processor, a map to include the edge, the map comprising the navigation path.

11. The method of claim 10, further comprising:
transmitting to a processing unit of a second autonomous vehicle, by a communication device coupled to the processor, an instruction to deactivate at least one of an edge detection routine or a guard detection routine when a presence of a guard disposed between the first autonomous vehicle and the edge is determined by the processor.

12. The method of claim 11, further comprising:
determining, by the processor, whether the guard is a known feature in the navigation path; and
upon determining that the guard is not a known feature, adjusting by the processor the map to include the guard.

13. The method of claim 11, further comprising:
transmitting to a controller of the second autonomous vehicle, by the communication device, an instruction to prevent speed reduction in the second autonomous vehicle as the second autonomous vehicle approaches the guarded edge in the navigation path.

14. The method of claim 11, wherein the instruction is based on the adjusted map that includes the edge.

15. The method of claim 10, further comprising:
transmitting to a controller of the first autonomous vehicle, by a communication device coupled to the processor, an instruction to reduce a speed of the first autonomous vehicle in the navigation path.

16. The method of claim 10, further comprising:
transmitting to a computing system, by a communication device coupled to the processor, the adjusted map, wherein the computing system is a remote computing system or a computing system of a second autonomous vehicle.

17. The method of claim 10, further comprising:
comparing, by the processor, a first cluster of points in the sensor data to a second cluster of points in the sensor data, wherein each point is representative of a distance from a camera of the first autonomous vehicle to a surface; and
determining, by the processor, a presence of the edge in the navigation path when the first cluster of points is significantly different from the second cluster of points.

18. The method of claim 17, wherein the first cluster of points is at least 50% different in distance from the second cluster of points.

19. The method of claim 17, further comprising:
determining, by the processor and based on the sensor data, a presence of a guard between the edge and the first autonomous vehicle.

20. A non-transitory computer-readable medium having instructions stored thereon that, when executed by one or more computer processors, cause the computer processors to perform operations comprising:
receiving sensor data collected by a sensor of a first autonomous vehicle;
determining that the sensor data is indicative of an edge in a navigation path of the first autonomous vehicle and that the edge is not a known feature; and
adjusting a map to include the edge, the map comprising the navigation path.
